(19) United States
(12) Patent Application Publication
(10) Pub. No.: US 2016/0280320 A1
(43) Pub. Date: Sep. 29, 2016

(54) Pedal Driving Device For Scooter

(71) Applicants: Wei Song, Houston, TX (US); Feng Zhu, Chang Tu (CN); Ning Zhu, Beijing (CN)

(72) Inventors: Wei Song, Houston, TX (US); Feng Zhu, Chang Tu (CN); Ning Zhu, Beijing (CN)

(21) Appl. No.: 14/668,763

(22) Filed: Mar. 25, 2015

(51) Int. Cl. B62M 1/32

(52) U.S. Cl. CPC B62M 1/32

(57) ABSTRACT

Present invention provided a Pedal Driving Device for two wheels Scooter. It comprises a front driving-leg and a rear driving-leg rotatively connected to both upper ends. A driving-shoe provided at lower end of rear driving-leg. It imitates human' action, kicking back to produce momentum. A supporting-sliding wheel provided at front of the driving-shoe. For a two wheel scooter, it can be equipped with one or two set of the present invention.

### CROSS-REFERENCE TO RELATED APPLICATIONS

None.

### FEDERALLY SPONSORED RESEARCH

None.

### SEQUENCE LISTING OR PROGRAM

None.

### BACKGROUND OF THE INVENTION

1. The Field of the Invention

The present invention relates to a novel pedal driving device especially for scooter type apparatus taking advantage of characteristics of scooter moving fast on the ground-level and momentum of imitating human' foot kicking back action.

2. Description of the Prior Art

Various scooter designs have been available for many years. Conventional scooters require a user to lift one foot from the scooter-board and down to the ground to kick back hard in order to get propulsion. It must be very tired for a longer riding. What is needed is a new improving design to overcome above shortcoming.

### SUMMARY OF THE INVENTION

A new Pedal Driving Device is designed for scooter type apparatus. It comprises a front driving-leg with an axle sleeve at lower end rotatively connected with a body of scooter, a rear driving-leg rotatively connected with the front driving-leg at upper end, a driving-shoe provided at lower end of the rear driving-leg, a set supporting-sliding wheel engaged in the front of the driving-shoe and a set of spring links two upper parts of the front driving-leg and the rear driving-leg. A user stands on foot-pedal and can easily push down quickly, pedal driving-leg device would keep providing momentum and the scooter moving forward.

### BRIEF DESCRIPTION OF THE DRAWINGS

Preferred embodiment of present invention will be two wheels scooter type apparatus. Now it will be described with reference to drawings in which:

FIG. 1 is a perspective view of the present invention.

FIG. 2 is a side view of a scooter provided with one set of the present invention as two driving-legs contracted.

FIG. 3 is a vertical view of FIG. 2

FIG. 4 is a side view of a scooter provided with two sets of the present invention.

FIG. 5 is a vertical view of FIG. 4.

FIG. 6 is a perspective view of first embodiment with one set of the present invention.

FIG. 7 is a perspective view of second embodiment with two sets of the present inventions.

FIG. 8 is a perspective view of operation of first embodiment.

FIG. 9 is an illustration as two driving-legs contracted.

FIG. 10 is an illustration as two driving-legs separated.

FIG. 11 is a detail view of driving-shoe and supporting-sliding wheel as two driving-legs contracted.

FIG. 12 is a detail view of driving-shoe and supporting-sliding wheel as two driving-legs separated.

FIG. 13 is a perspective view of driving-shoe.

FIG. 14 is a diagram of contract spring with limiter.

FIG. 15 is a perspective view of another design of driving-leg with one-way clutch wheel.

FIG. 16 is a diagram of one-way clutch wheel with teeth and pawl outside.

FIG. 17 is a diagram of one-way clutch wheel with teeth and pawl inside.

### DESCRIPTION OF THE PREFERRED EMBODIMENT

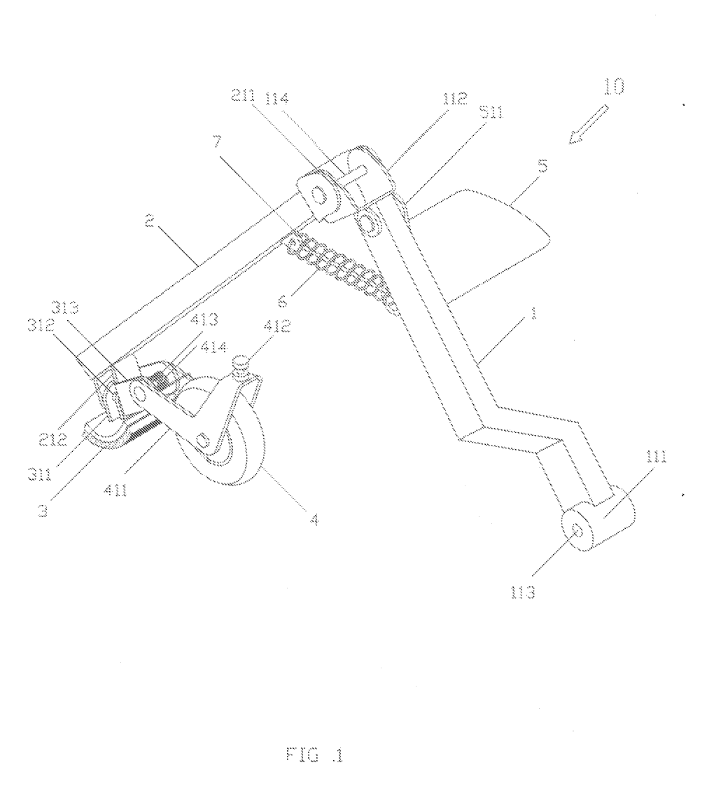

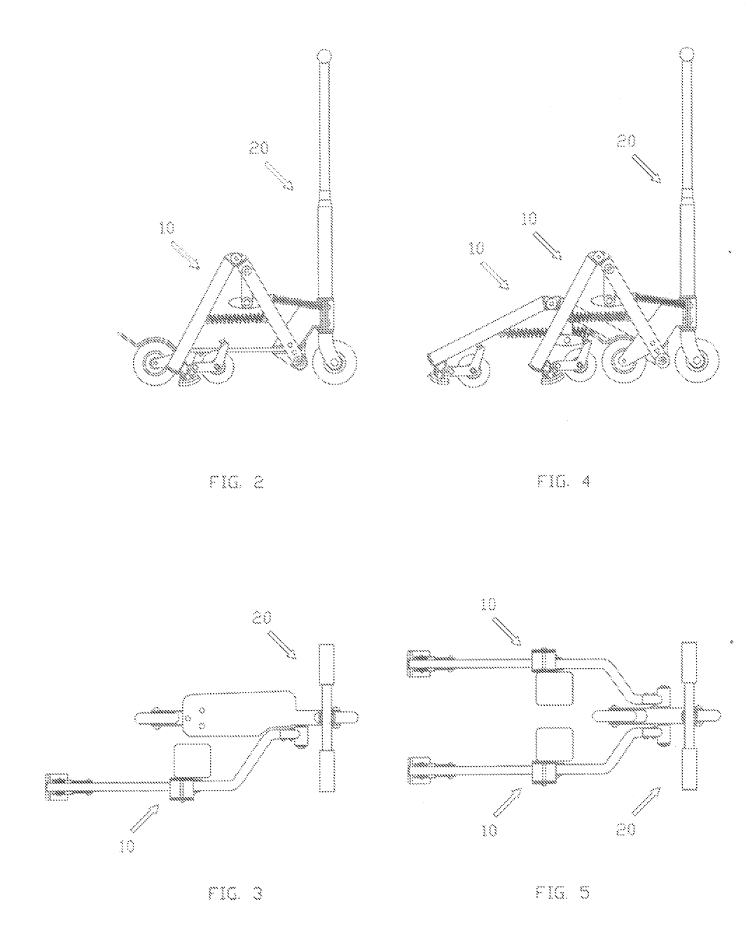

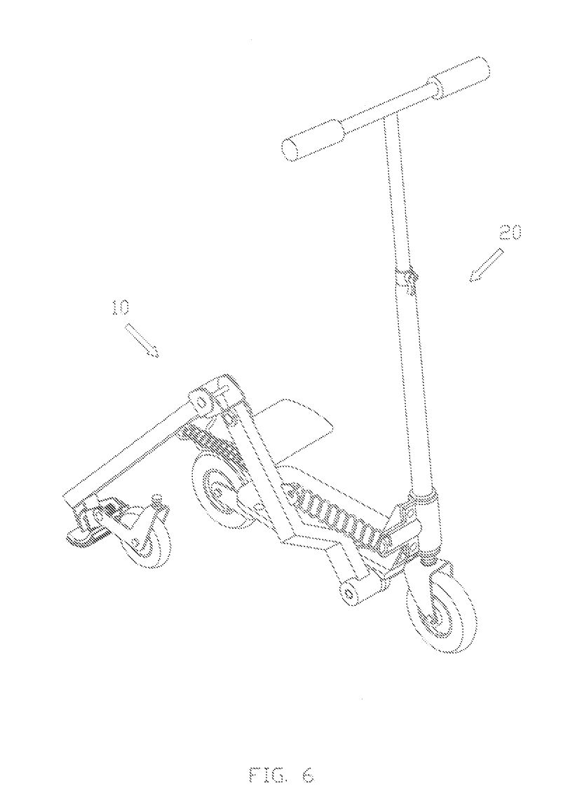

Referring first to FIG. 1: The device 10 includes:
Front driving-leg 1;
Rear driving-leg 2;
Axle sleeve 111 with axle hole 113 secured to lower end of front driving-leg 1;
Hinge 112 secured to upper end of front driving-leg 1;
Hinge 211 secured to upper end of rear driving-leg 2;
Pedal 5 rotatively engaged on upper part of front (rear) driving-leg 1 (2) by connecting rod 511;
Yoke 212 secured to lower part of rear driving-leg 2;
Driving-shoe 3 with yoke 311 rotatively connected to yoke 212 by pin axle 312;
Fork 313 secured to front side of yoke 212;
Frame 411 rotatively connected to fork 313;
Supporting-sliding wheel 4 counted on frame 411;
Adjustable limiter 412 provided at upper end of frame 411;
Axial spring 413 encircled pin axle 414;
Spring 6 connected to upper parts of front driving-leg 1 and rear driving-leg 2;
Limiting rope 7 provided inside of spring 6 and secured to both front driving-leg 1 and rear driving-leg 2.

FIG. 2, 3 are side view and vertical view showing first embodiment of scooter 20 provided with one set of present invention 10.

FIG. 4, 5 are side view and vertical viewing showing second embodiment of scooter 20 provided with two sets of present invention 10.

FIG. 6 is a perspective view of FIG. 2, 3.

FIG. 7 is a perspective view of FIG. 4, 5.

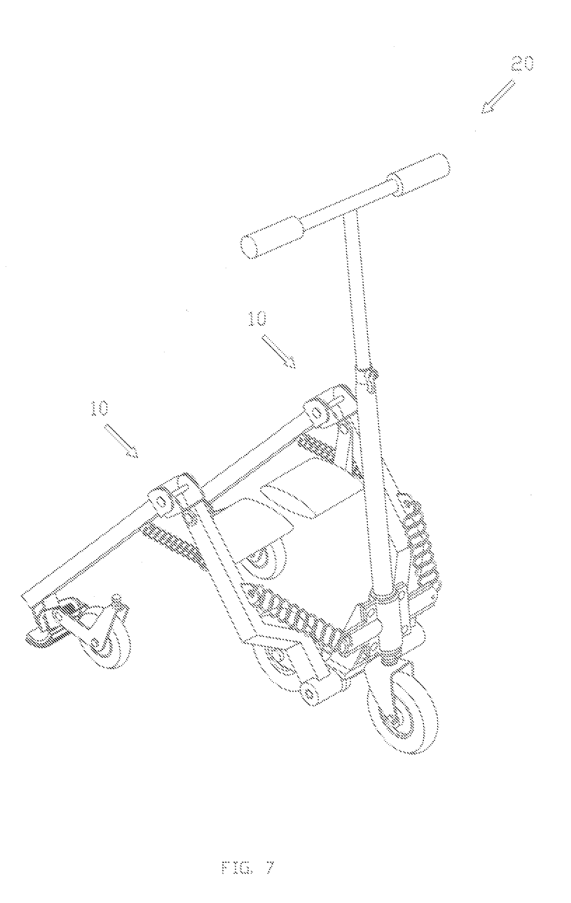

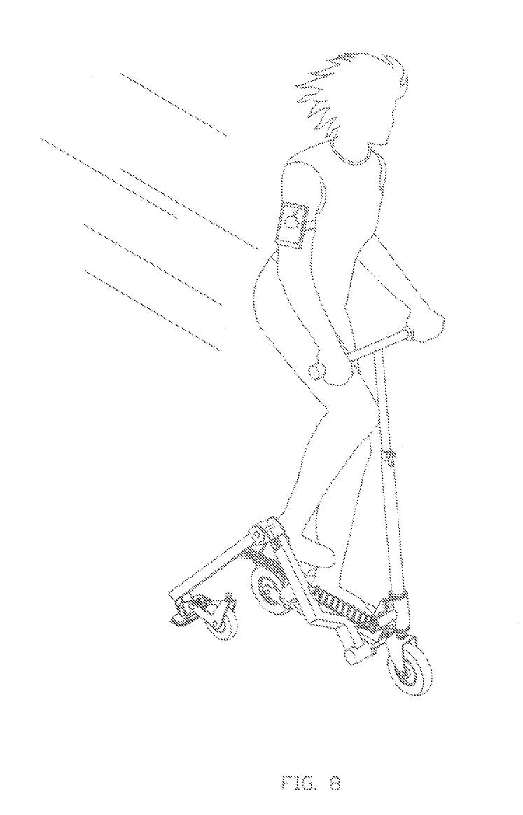

FIG. 8 is a perspective view of operating illustration of the first embodiment with one set of the present invention.

FIG. 9, 10 illustrate principle of drive. Axle sleeve 111 rotatively connected with axle 113a secured to scooter 20. Spring 2011 connected with front driving-leg 1 and body of scooter 20. While a user with one foot push down pedal 5, driving-shoe 3 will touch ground and two driving-legs 1 and 2 get separating each other simultaneously till blocked by limiter 7. During the process, as the result of friction between driving-shoe 3 and ground, front part of front driving-leg 1 is pushed forward together with whole body of scooter 20. As the user rise his foot, pedal 5 moves upwards due to puling-force of spring 6 and spring 2011, front driving-leg 1 and rear driving-leg 2 contracting towards each other, driving-shoe 3 leaving ground. Spring 2011 can also be replaced by an axial spring around axle 113a.

FIG. 11, 12 shows the detail working principle driving momentum. As pedal 5 rising to the highest position, driving-shoe 3 is in touch with the ground and supporting-sliding wheel 4 too. Due to frame 411 is rotatively connected with fork 313, supporting-sliding wheel 4 touches the ground only under elasticity of axial spring 413 and at present it did not bear any load, only slidinging, shown as FIG. 11. While front driving-leg 1 and rear driving-leg 2 keep separating, degree between rear driving-leg 2 and the ground becomes smaller and smaller, limiter 412 will get in touch with lower part of rear driving-leg 2 and at the same time driving-shoe 3 separate from the ground shown as shown in FIG. 12. That is: once driving-shoe 3 finished kicking back action, it would break away from the ground instead of supporting-sliding wheel 4 becoming load-bearing wheel.

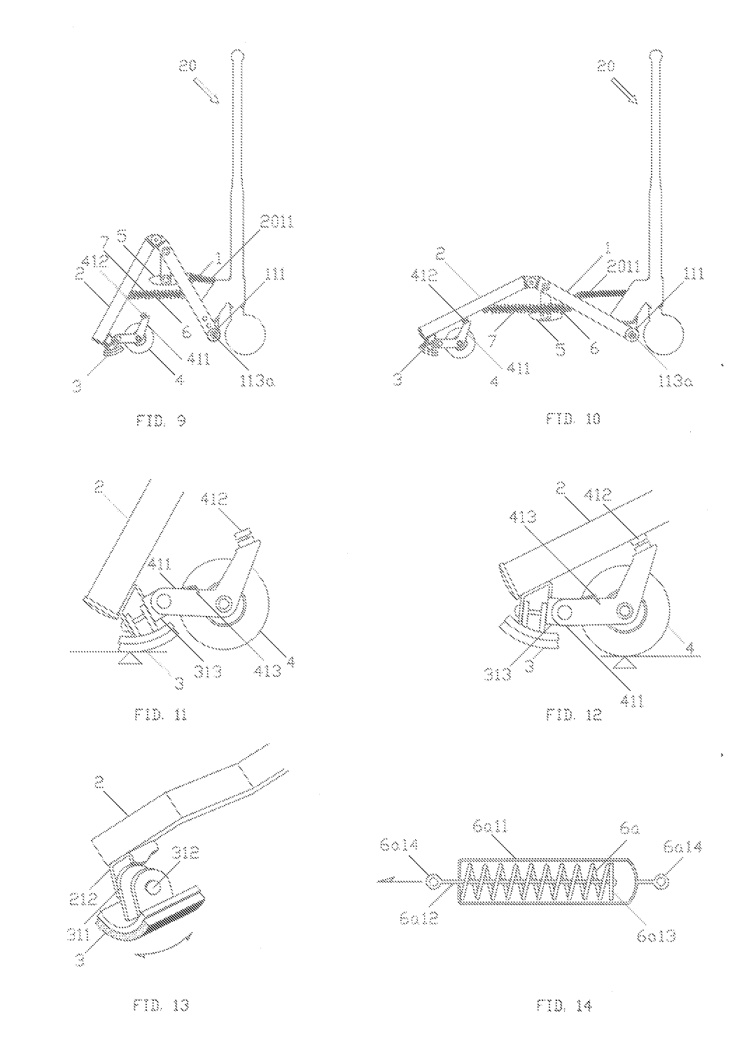

FIG. 13 is a perspective detail view of driving-shoe 3. Driving-shoe 3 is rotatively engaged to yoke 212 by yoke 311 as well pin axle 312.

FIG. 14 shows another elastic component. Two rings 6a14 connected with two driving-legs 1 and 2. While pulling rod 6a12 is pulled out of sleeve 6a11, spring 6a is compressed by block 6a13 secured to end of pulling rod 6a12 and stopped by left bottom of sleeve 6a11.

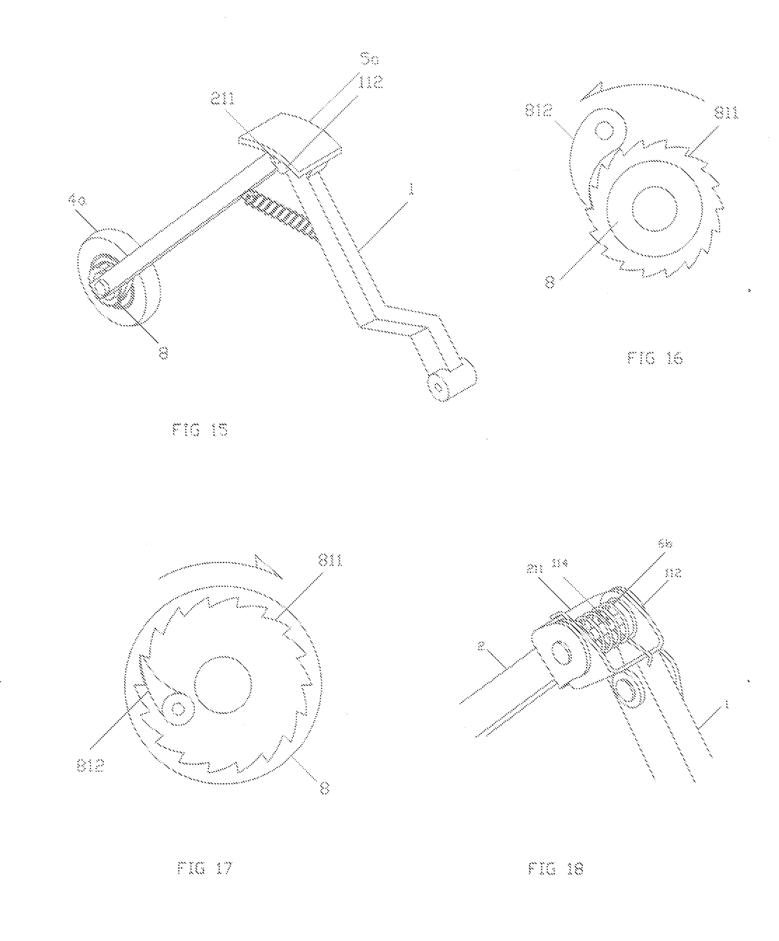

FIG. 15 is a perspective view of another different structure of the present invention with one-way clutch wheel provided at lower end of driving-leg 2 and pedal 5 provided upper parts on joint of front driving-leg 1 and rear driving-leg 2 connecting with hinge 112 and 211.

FIG. 16 shows structure of one-way clutch wheel 8 which comprises ratchets 811 and pawl 812 arranged outside of hub. Pawl 812 always keeps in touch with ratchets 811 by a small spring (not shown in FIG. 16, 17). While wheel 4a runs forward check pawl 812 would slide over teeth of ratchets 811. While wheel 4a reverses ratchets 811 will be blocked by pawl 812.

FIG. 17 shows other one-way clutch wheel with ratchets 811 and pawl 812 arranged inside of hub.

Although preferred embodiment of the present invention has been shown in the foregoing specification, it will, of course, be understood that various modifications and changes may be made therein without departing from the invention. It is therefore, intended that the following claims cover all such modification and changes as may fall within the true spirit and scope of the present invention.

What is claimed is:

1. Pedal driving device for a scooter comprising:
(a) a front driving-leg provided with an axle sleeve at lower end and a hinge at upper end;
(b) a rear driving-leg provided with a hinge at upper end rotatively joined to said hinge of said front driving-leg;
(c) a pin axle pinned to said hinge of said front driving-leg and to said hinge of said rear driving-leg;
(d) a yoke provided with a fork secured to lower end of said rear driving-leg;
(e) a driving-shoe hinged on said yoke;
(f) a supporting-sliding device rotatively engaged to said fork;
(g) a pedal engaged on upper part of said front and rear driving-leg;
(h) an elastic components connected to said front driving-leg and said rear driving-leg;
(i) a limiter connected to said front driving-leg and said rear driving-leg.

2. A device according to claim 1 wherein said driving-shoe is confined to swing in left and right direction.

3. A device according to claim 1 wherein said supporting-sliding device comprises a frame with an adjustable limiter rotatively engaged to said fork, a wheel rotatively mounted on said frame, a pin axle and a torque-spring.

4. A device according to claim 1 wherein said driving-shoe comprises a wheel with a one-way clutch wheel provided at a lower part of said rear driving-leg means.

5. A device according to claim 1 wherein said elastic components comprises a spring, a pulling rod provided inside of said spring, a block secured to an end of said pulling rod and a sleeve encircling said spring.

6. A device according to claim 1 wherein said elastic components comprises a torque spring provided around said pin axle pinned to said hinge of said front driving-leg and said hinge of said rear driving-leg.
